(19) United States
(12) Patent Application Publication
(10) Pub. No.: US 2002/0188950 A1
(43) Pub. Date: Dec. 12, 2002

(54) Low speed data port for data transactions and information

(75) Inventors: Steven Soloff, Tamarc, FL (US); Angela M. Trujillo, Weston, FL (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(73) Assignee: Hughes Electronics Corporation

(21) Appl. No.: 09/733,229

(22) Filed: Dec. 7, 2000

Related U.S. Application Data
(60) Provisional application No. 60/201,039, filed on May 1, 2000.

(51) Int. Cl. H04N 7/20

(52) U.S. Cl. 725/63; 725/68

(57) ABSTRACT

A system and method for providing data transactions and web information and services to a user integrated with conventional television program viewing, such as provided by a DSS is taught. The system requires no additional communication hardware, such as a modem. The system also employs the users existing browser to view information. An application to automate delivery of such data transactions and web information and services and to users who may not have access to a conventional ISP is also taught.

### BACKGROUND OF THE INVENTION

1. Field of the Invention

The invention generally relates to methods and systems for communicating data and more specifically to methods and systems for transmitting and receiving data in an interactive satellite-based broadcast system.

2. Description of the Prior Art

In today's world, the demand for information available on the Internet, the global network that connects a multitude of users, is unparalleled. The speed and volume of Internet information continues to grow and the ease at which this information can be obtained makes the Internet the fastest growing technology of our generation.

Typically, all the end-user needs to access the vast amounts of information made available on the Internet is viewing means such as a Personal Computer (PC) or a Personal Data Assistant (PDA), and means to connect to an Internet Service Provider (ISP), a company or organization that provides a local connection to the Internet, either through terrestrial land lines or through a digital cable connection.

Users typically use a terrestrial telephone line for their modem connection. However, a problem arises in areas of the world where phone or cable lines are impractical. This could be due to the high cost of running lines through difficult terrain or due to the prohibitive cost to the end user of a modem connection. In these cases, it is much more practical to make the information available to the user via satellite communications much like the satellite television industry.

The convergence of satellite and Internet technologies is one of the more exciting aspects of today's satellite revolution. Satellites are proving to be highly effective multimedia platforms because of their ability to deliver information at high data rates to virtually any location within a given signal coverage zone.

Typical satellite-Internet delivery systems are based on Asynchronous Transfer Mode (ATM) architecture that uses a low-speed modem connection for user information requests and a high-speed satellite channel to deliver to each user the requested information.

Satellites have had a significant impact on the television industry. With an orbital location so far from earth, satellites transmit a usable signal over a broad footprint. The large geographical coverage of satellite makes it possible to serve thousands, if not millions, with a single satellite.

The basic components of a satellite system are one or more transmitting earth stations, the uplink, the satellite, the downlink, and one or more receiving earth stations. The communications satellite is a radio relay operating in space for ten or more years without the need for on-site servicing or adjustment. Satellites contain transceivers that receive and transmit signals, including video programming, telephone calls and data. They operate in a vacuum at a location exposed to extreme temperature changes.

In conventional delivery of “web” information, an Internet ISP is required, as well as communications hardware, such as a modem. In areas where a conventional ISP is not available, web content and web-like information is generally unavailable.

In 1995, Hughes Network Systems (“HNS”) introduced its DirecPC® satellite delivery system, which provides subscribers in North America with high-speed downloads from the Web.

In 1997, HNS released its DirecDuo® multimedia system, which gives subscribers in the USA access to both high-speed Internet connectivity and the DirectTV® bouquet of digital Direct-To-Home (DTH) TV services all from a single fixed satellite dish.

HNS also broadcasts multimedia content directly to its subscribers in what is called the “push mode”. HNS is responsible for the selection of multimedia content; therefore, no return link is required. Subscribers can choose from a list of the most popular sites on the Internet and have those sites delivered automatically to their hard drives over high-speed satellite links.

Once again, the problem arises when the end-user cannot dedicate a telephone line or a cable to receive the information from the satellite.

Accordingly, what is needed in the art is a system and method for providing data, particularly web content and information services, to users, integrated with conventional television program viewing such as provided by Direct Satellite Service (DSS), without the requirement that the user possess a dedicated telephone line connection.

It is, therefore, to the effective resolution of the aforementioned problems and shortcomings of the prior art that the present invention is directed.

### SUMMARY OF THE INVENTION

The present invention is a one way broadcast system offering information such as Web-content information, to the subscriber's PC through the low-speed serial port in all current Integrated Receiver/Decoders (IRDs). AN IRD is a device that receives satellite signals and decodes signals that have been encrypted. Typically, use of the low-speed serial data port on the user's IRD was limited to debugging the IRD and not for data transfer. Although limited by the low speed transfer of data through the serial port, and therefore limited to the amount of information that can sensibly be transferred to the user, the present invention utilizes serial data transfer technology and takes advantage of the end user' facilities, namely a PC and a browser, to deliver information to users.

Delivery and processing of the received information is managed through the use of a software application in the viewing device. The software tool automatically downloads the information and saves it.

The information is first acquired and processed at a local information retrieving and editing center. The information is sent via terrestrial link to a Central Broadcasting Center where it is integrated into a conventional broadcast system and uplinked to a satellite. The subscriber, “in country”, receives the data stream via their existing satellite dish antenna into their IRD. The IRD is then connected to the subscriber's PC via the serial port. The subscriber must tune the IRD to the data channel and leave both the IRD and the PC on for at least a predetermined amount of time. Data flows through the IRD directly to the hard drive on the PC. Specialized client software can be installed on the subscriber's PC to enable reception, processing and viewing of the data.

In the preferred embodiment, the information transmitted via the satellite network is HTML-formatted data retrieved from the Internet. To the customer, the received information appears as a seamless, fast Web site. The user can use his or her own installed browser, or a browser can be provided as part of the installation process. Each time the user starts the browser, a Contents Page appears, containing headlines, links to news stories and news sections, such as international, local sports, weather, Direct TV, etc.

The present invention ties a channel in a television viewing system such as a DSS, with data delivery such that the channel can transmit data related to a selected program, e.g. a program guide or related information. Delivery of the information requires no extra channel allocation because the data is attached to existing channels. The additional data and information changes as the user changes channels.

In the preferred embodiment, the data and information is delivered in HTML format so that it may be viewed with any web browser. However, the information need not be in HTML format. For example, television program guide information can be added to the data stream to provide users with the ability to receive advance television program schedules.

In application to a DSS system, the information is transferred to a viewing device, such as a computer terminal or PDA through a cable connection or other simple link, such as a standard RS-232 serial connection.

Specifically, the present invention is a DSS terrestrial-satellite communications network for delivering information to a viewing device without the need for additional communications hardware such as a dedicated telephone line or cable. The invention comprises: means, situated at a first location, for selecting, acquiring and editing certain information, such as HTML-formatted information from the Internet; a first network computer having memory storage means for storing the information; a central network computer situated at a second location; means for transmitting the information from the first network computer to the central network computer; one or more communication satellites for receiving and transmitting broadcast signals; uplink means coupling the information from the server to the satellites in the form of broadcast signals; downlink means coupling the broadcast signals from the satellites to a receiving antenna situated at a third location within the satellite's coverage area, the receiving antenna receiving the downlink broadcast signals from the satellites; an IRD connected to the receiving antenna wherein the IRD descrambles the incoming signals; a viewing device, such as a PC or a PDA, situated at the third location and connected to the IRD via a low-speed serial data port, the viewing device containing a browser for displaying the signals received from the IRD on the viewing device, said signals representing, for example, HTML-formatted Internet information; and a memory storage device situated in the viewing device for storing the information, wherein software provided to the user allows for the information to be automatically stored on the user PC's hard drive.

In the preferred embodiment, the central network computer bundles the selected Internet information with audio and video DSS signals in the uplink to the satellite. At the user's IRD, the Internet information is then extracted from the audio and visual signals, where it is transmitted via serial link to the user's viewing device.

In an alternate embodiment, the information is not HTML information from the Internet, but is instead television program listings, which are sent in the manner described, i.e. transmitted to the central broadcasting center where it is bundled with television audio and video signals, uplinked to one or more satellites, downlinked to multiple users, descrabled at the user's IRD and transmitted via the serial port to the user PC's hard drive where it is viewed on the user's viewing device. Once again, the user does not require a modem to receive the information, only a serial cable connection from the serial port of the IRD to the user's PC. The program guide data presents the user with advanced television schedules, up to thirty days in advance.

The invention is applicable for any type of information, not only HTML-formatted information. Television program listings are merely one example. The common feature to all of the possible applications is that the user need not possess a modem, or, in the case of Web-content information, any access to an Internet Service Provider.

An important feature of the preferred embodiment of the present invention is that the information broadcast from the central network computer at a Central Broadcast Center is related in subject matter to the bundled audio and video broadcast signals. A server at the Central Broadcast Center couples information received from an Editor Content Server with channel broadcasts having similar subject matter content. In this way, the user receives information having subject matter the same as or similar to the subject matter of the video channel he or she is currently tuned into. When the user changes the channel of his or her television, new information, having similar subject matter as the new channel is automatically selected, bundled with the corresponding audio and video signals, and broadcast to the user.

The IRD incorporated into a DSS terrestrial-satellite Internet communications network receives the dowlinked broadcast signals of bundled audio, video, and data information. The IRD includes a first port to provide linking means to a television and a second port to provide linking means to a computer, where the second port is a low-speed serial data port capable of transferring the data information to the viewing device via a serial cable without the need for a dedicated telephone line and access to an ISP. The IRD contains the intelligence to extract the information from the audio and video signals; the information is sent to the viewing device via the serial connection, and the audio and video signals are sent to the user's television.

It is therefore one object of the present invention to provide data to a user that is integrated with conventional television program viewing, such as provided by a DSS, and without requiring additional communications hardware.

It is another object of the present invention to send HTML-formatted information, retrieved from the Internet, to multiple users, wherein the user need not possess a modem or a dedicated telephone line.

It is another object of the present invention to send advanced television program listings to users via the serial connection on the user's IRD.

It is yet another object of the present invention to automate delivery of such data transactions and web information and services to users who may not have access to a conventional Internet Service Provider.

It is still yet another object of the present invention to utilize the serial port of the user's IRD, previously used only for debugging purposes, to provide serial data transmission to the user.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

In accordance with these and other objects which will become apparent hereinafter, the instant invention will now be described with particular reference to the accompanying drawings.

### BRIEF DESCRIPTION OF THE DRAWINGS

FIG. 1 is a block diagram illustrating the data services architecture of the present invention.

FIG. 2 illustrates the architecture of the subscriber's hardware components of the present invention.

FIG. 3 is a block diagram illustrating the data services installation flowchart of the present invention with language selection.

FIG. 4 is a block diagram illustrating a continuation of the present invention's installation flow including browser verification.

FIG. 5 is a block diagram illustrating a continuation of the present invention's installation flow including check for port availability.

FIG. 6 illustrates the IRD-PC connection via the IRD's serial port.

FIG. 7 illustrates the architecture of the upstream subsystem of the present invention.

FIG. 8 illustrates the upstream subsystem of the present invention in greater detail.

FIG. 9 illustrates the broadcasting subsystem architecture of the present invention.

FIG. 10 is a block diagram illustrating the data services architecture of the program guide embodiment of the present invention.

FIG. 11 is a block diagram illustrating the architecture of the upstream subsystem for the program guide embodiment of the present invention.

FIG. 12 is a block diagram illustrating a continuation of the upstream subsystem for the program guide embodiment of the present invention.

FIG. 13 is a block diagram illustrating the architecture of the user subsystem for the program guide embodiment of the present invention.

FIG. 14 is a block diagram further illustrating the architecture of the user subsystem for the program guide embodiment of the present invention.

FIG. 15 shows a sample program guide that a user would see on their viewing screen.

### DESCRIPTION OF THE PREFERRED EMBODIMENTS

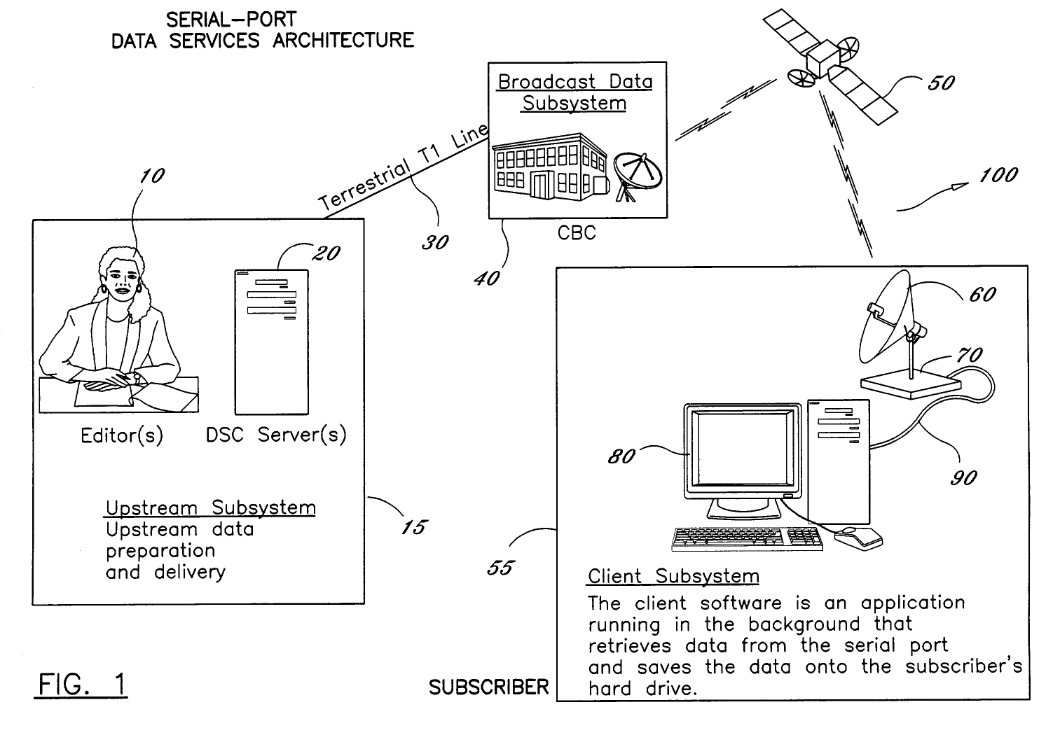

Referring to FIG. 1, the system architecture of the present invention 100 is shown.

An editor 10 at a Data Service Center (DSC) 15, such as Florida, chooses web-content information, in the form of HTML data. The data is prepared and placed on a Data Service Center Editor 20. The DSC outputs the data contents via a terrestrial T1 link 30 to a remote Central Broadcast Center (CBC) 40, such as California, where it is uplinked to one or more communications satellites 50, such as G8i satellites.

A user, at a location 55 within the satellite's footprint, in South America for example, receives the data stream via his or her satellite dish antenna 60. The information is then forwarded along to an Integrated Receiver/Decoder (IRD) 70. Preferably, the data stream is bundled along with the conventional audio and video television signals that ultimately reach the user's television. IRD 70 is connected to the user's PC, PDA or other data viewing device 80 via a standard serial cable 90 from the IRD's 16550 UART serial port. The user must tune IRD 70 to the data channel and leave both the IRD and the PC on for a predetermined amount of time to receive a complete data content update.

Data flows through IRD 70 directly to the hard drive of PC 80 through the serial port. Specialized software is supplied to the user and can be installed on the user's PC to enable the reception, processing and viewing of data. The software captures the incoming data, breaks it into files, and converts it into HTML form. The browser on the user's PC allows easy viewing of the HTML-formatted data. Because the HTML data is transmitted in serial form via cable 90, no dedicated modem is necessary to receive the information. Further, no ISP is needed to access this Internet-extracted information.

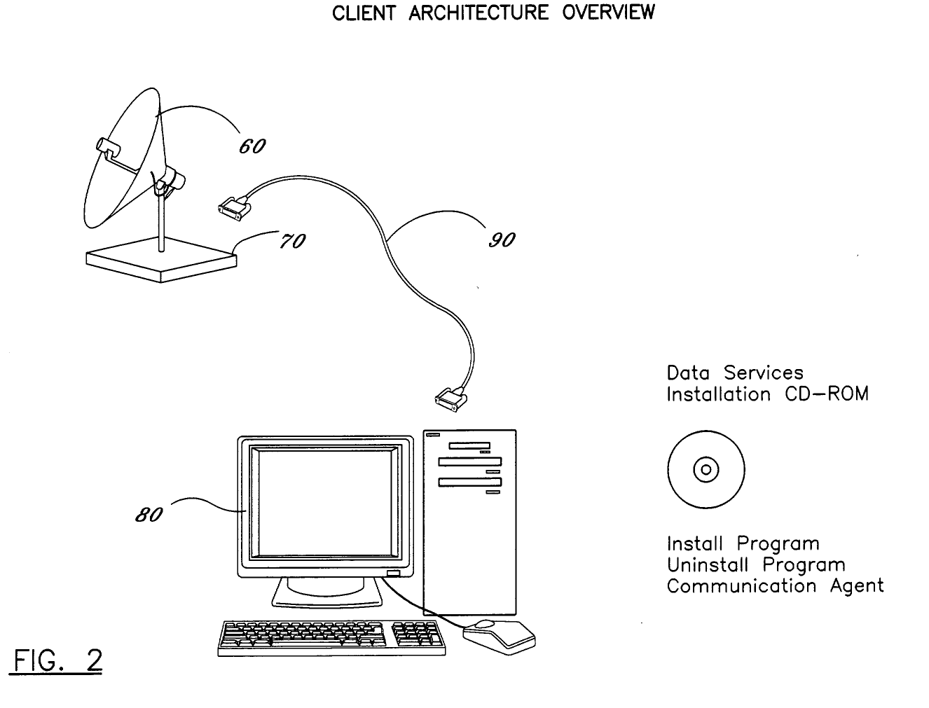

FIG. 2 illustrates the downstream or client architecture used by the user to receive the HTML data. Satellite dish antenna receives the downlinked broadcast from satellites 50. Antenna 60 is connected to the user's PC 80 via a standard RS-232 serial connector, which feeds the information received from satellite 50 to the PC's standard serial port.

The user must have a satellite dish antenna, an-IRD connected to the antenna, and a viewing device such as a PDA or a PC. The subscriber's PC must have certain minimum requirements. It must include an available serial port, capable of reliably running at 4.6 kbs, a 486 or higher processor, 8 MB of RAM and Win95 or Win NT operating system. 55 MB of available hard drive space is required. 50 feet of serial cable is provided to the subscriber along with the hardware package.

The subsystem software supplied to the subscriber includes an install program situated on a memory storage device such as a CD-ROM and will start immediate upon insertion in the drive. The install program setup and installs all required files.

The install program will start automatically when the subscriber inserts the installation software residing on the CD-ROM into the drive. The install program sets up and installs all required files and adds all required system registry entries.

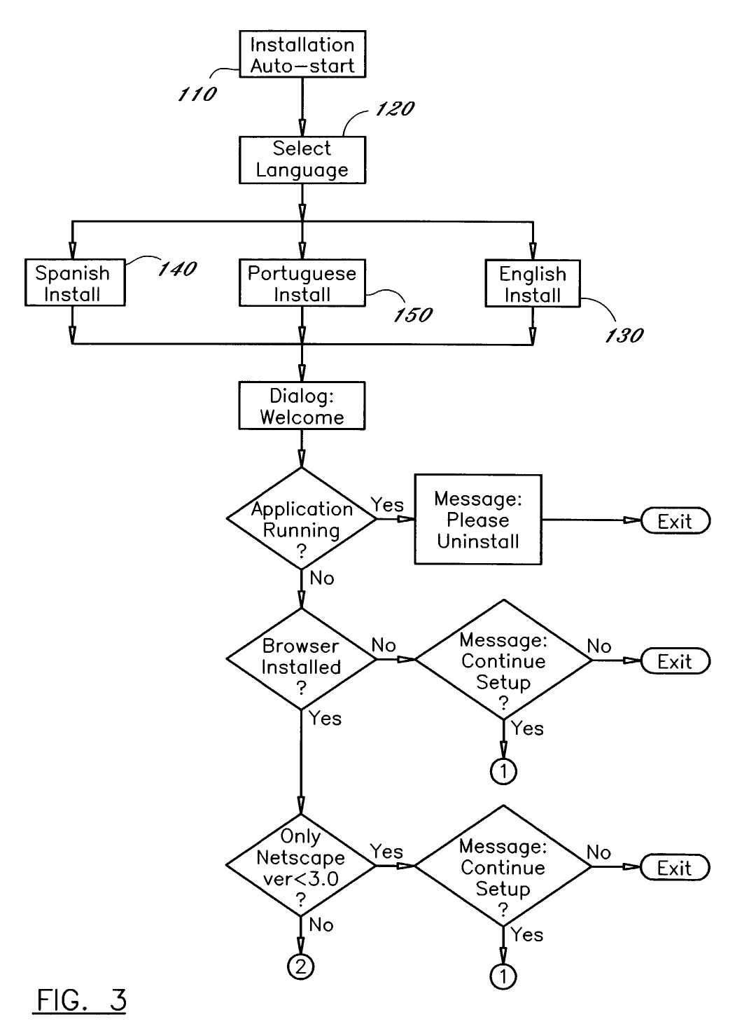

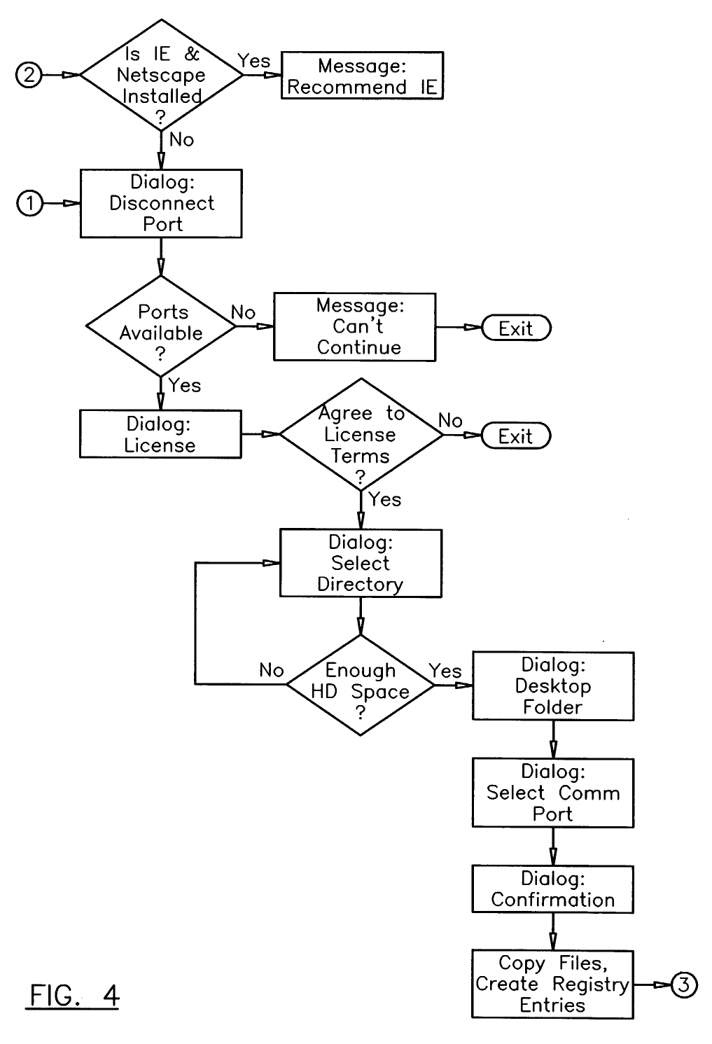

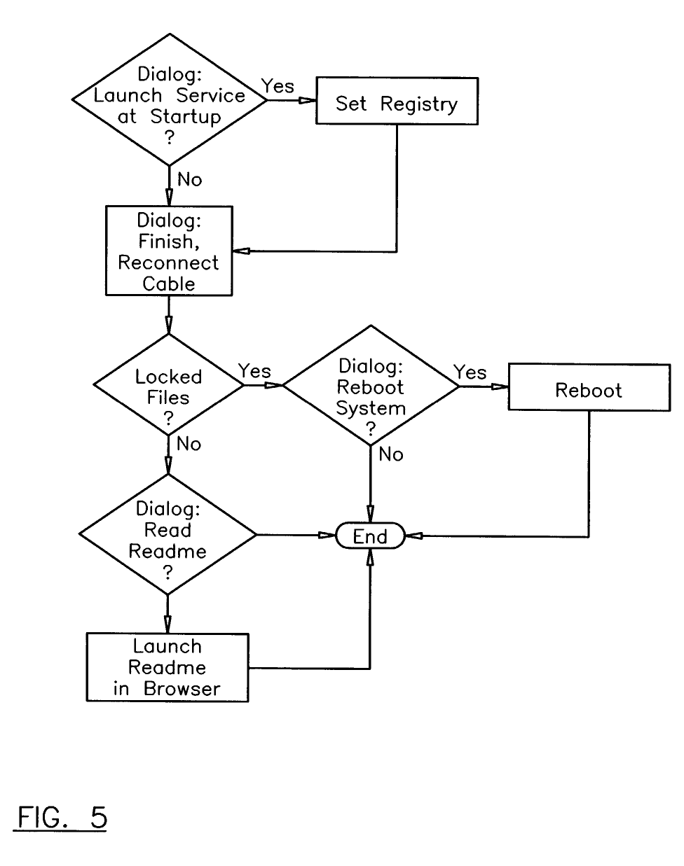

FIG. 3 illustrates the process of the installation software of the present invention. Referring to FIG. 3, after the installation step 110, the subscriber can choose from a variety of languages 120 in which to view the received information including English, Spanish and Portuguese 130-150. The install program determines which browser has been installed, the available communications port and the available space on the user's hard drive. This is illustrated in FIGS. 4 and 5.

The subscriber must have a browser installed in his or her PC in order to view the HTML-formatted data. If not, one is supplied to the subscriber. Microsoft Internet Explorer 4.0 or Netscape 3.0 or higher are both acceptable.

A Data Service Communications Agent (DSCA) is a small executable application program residing in the user's PC 80. The program informs the user when data is either being transmitted (an icon on desktop appears red) or that data has been received (an icon on desktop appears blue). The program is a C++ program running under the Microsoft windows 95/98 operating system. The program runs as a standard Windows application running in the background, so there is no user interface. The only visible presence on the user's desktop is the appearance of the icons.

The DSCA program monitors the PC port for data coming from IRD 70 and parses and stores the data in the user's hard drive. Upon execution, the DSCA program opens a connection to a standard serial port connected by a cable modem to the low speed port of IRD 70. It will then enable IRD 70 to send and monitor continuous data sent from the IRD. The DSCA program is installed to launch at startup.

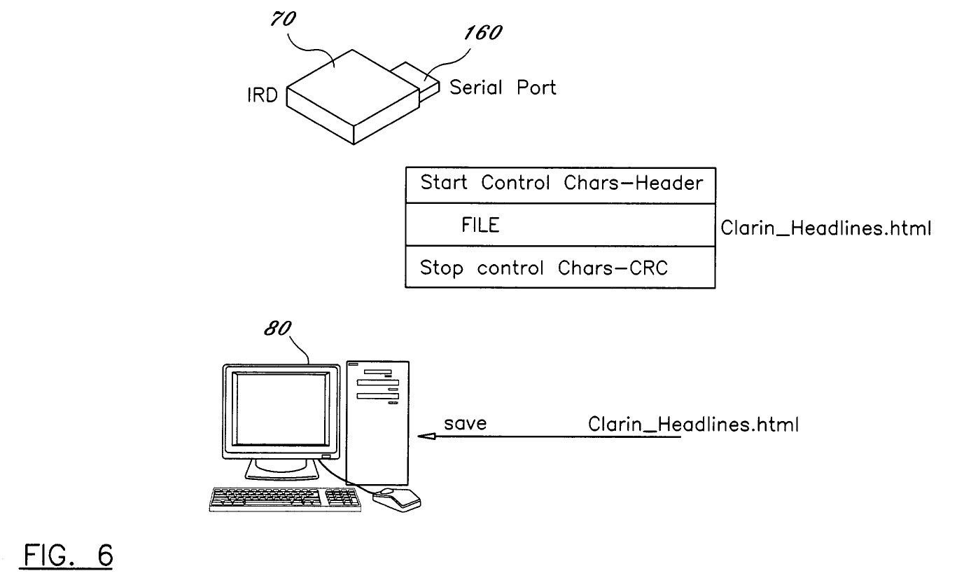

Referring to FIG. 6, data received from the serial port 160 of IRD 70 is stored in files residing on the user's hard drive for later retrieval by the user. The data received from IRD 70 is in the form of framed files. Received data is first stored in a temporary file. Each file includes a Cyclic Redundancy Code (CRC) that is checked to verify that the contents are correct. If the CRC is incorrect, the data is discarded.

The DSCA program extracts the path, the file name, the date stamp and the file type from the header of each file. The path and file name define a location relative to the “base” directory path on the user's PC. The user's base directory path is saved in the Windows Registry at installation.

The date and time stamp are used to determine if the file has already been received that day and need not be replaced. If the file does not already exist, then any required post-processing indicated by the file type such as directory deletion or link fix ups, will be performed and the file will be removed to its proper location.

Data received from the IRD data port is framed. Framing involves adding characters to the data to insure that the data is received accurately. Each file that is sent is framed individually, although the files may be broken into smaller frames to increase data transfer reliability. The general layout of a frame is:

<start sequence><file header><file data><end sequence><crc>

The <start sequence> is an ASCII control character sequence <DLE><STX>. <DLE> represents the ASCII Data Link escape character whose decimal value is 16. <STX> is the ASCII Start of Text character, decimal value 2.

The <file header> consists of the file name, timestamp and message type separated by semicolons.

The <file data> is the binary file data contents of the file being sent. Since the file data is binary, it is possible that the <DLE> character exists within the data, and if paired with the <STX> or <ETX>, could give a false framing signal. To prevent this, the binary data in the file is scanned and if a <DLE> is found, it is replaced with the sequence <DLE><DLE>. Only the original <DLE> is used in the CRC calculation.

The end sequence is the ASCII control character sequence <DLE><ETX>. <DLE> represents the ASCII Data Link escape character whose decimal value is 16. <ETX> is the ASCII end of Text character, decimal value 3.

<crc> is the cyclic Redundancy Code calculated at the transmitting end. It is a two-character sequence, <CRC_HIGH_BYTE><CRC_LOW_BYTE>. These are binary values. The receiving end calculates the CRC of the data and compares it with the value sent by the transmitting end. The crc is calculated across all of the characters between the <start sequence> and the <end sequence> after redundant <DLE> characters have been removed.

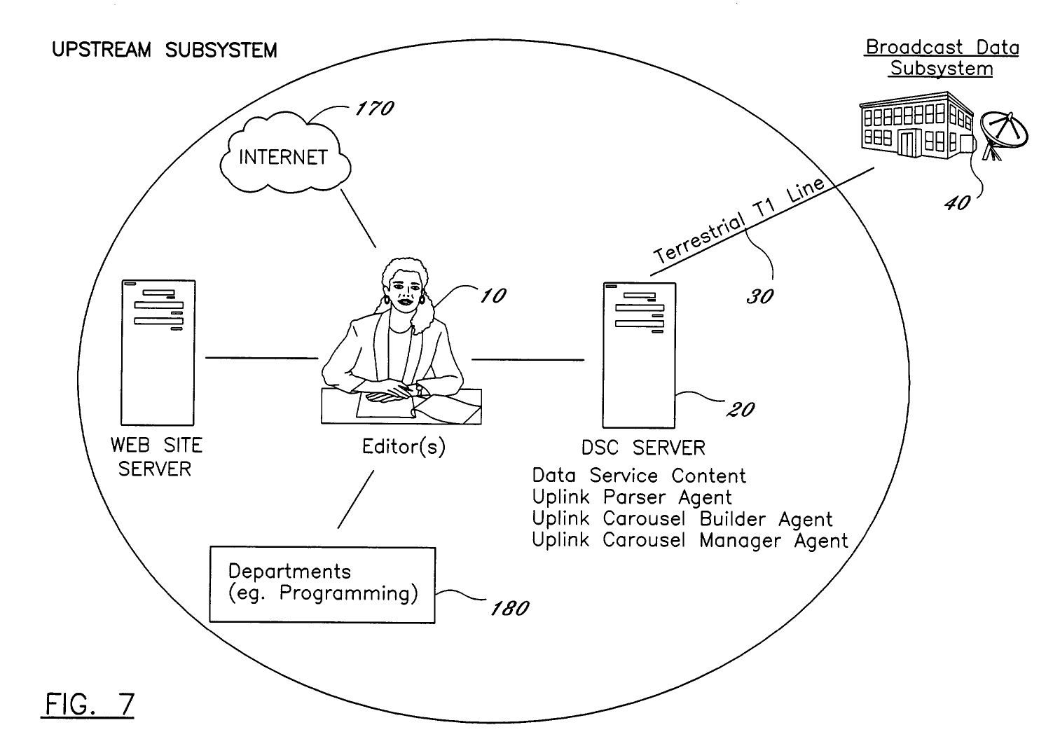

FIG. 7 refers to the upstream subsystem of the present invention. Here, the editor 10 selects certain information from the Internet 170, which is to be sent to end-users. This information could include television program guides, overseas newspaper headlines or news stories. Editor 10 uploads the information to DSC Server 20 at Data Service Center (DSC) 15. DSC server 20 is preferably a 400 MHz, NT PC. The information is then sent via T1 terrestrial line 30 to CBC 40.

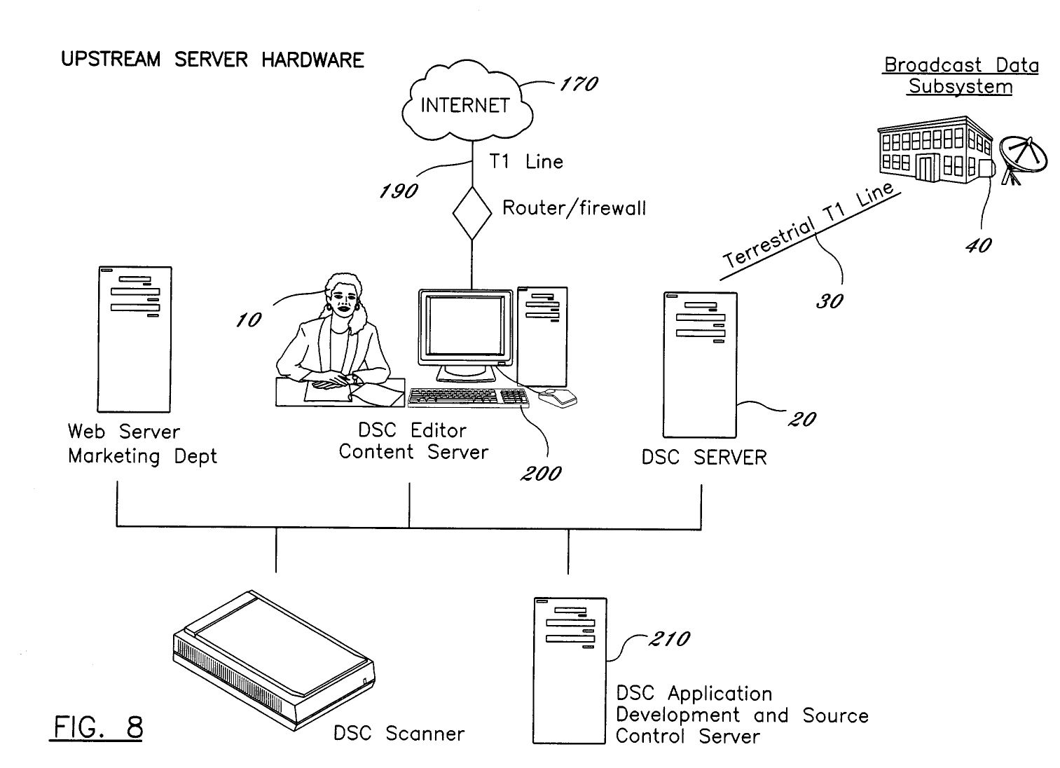

FIG. 8 illustrates the upstream subsystem of the present invention in greater detail. Included in this subsystem are three servers. Information is obtained from the Internet 170 via a T1 line 190 to a DSC Editor Content Server (ECS) 200. Editor 10 builds the service contents on ECS 200. Web Site development software tools such as FRONTPAGE® and NETSCAPE EDITOR are installed on ECS 200. DSC Application Development and Source Control Server (ADSCS) 210, preferably a 450 MHz, 128 MB RAM NT machine, processes and formats the Internet information. ADSCS 210 includes off-the-shelf software applications such as MS Visual Studio Enterprise Edition (v6.0) with a C++ and VB compiler, and SourceSave; Borland C Compiler version 4.5; InstallShield version 5.5; and Microsoft Access.

The information is then sent to DSC Server 20, which transmits the information via T1 terrestrial line 30 to CBC 40. DSC Server 20 includes several Windows applications each having a Graphical User Interface (GUI). An Uplink Parser application allows the editor to search and replace text strings on selected files or subdirectories. An Uplink Carousel Builder application (UpBuild) is the content editor's interface into the system. UpBuild is written in Visual Basic version 6.0 and utilizes ActiveX Data Objects for access to Microsoft Access compatible databases. The target platform is Windows NT 4.0.

The UpBuild application allows the editor to enter filenames and related file properties into a carousel database. Data entered into the fields of the carousel database determine which files will be transmitted. The carousel database is built by a Carousel Builder application and read by the Uplink Carousel Manager application.

The Uplink Carousel Manager application (UpCarouselMgr) is responsible for sending data files to the user's PC over the satellite data services port. UpCarouselMgr reads the carousel database for information about which fields should be sent over the satellite network and then adds header information and frames the data so that it can be reliably and accurately transferred. UpCarouselMgr is written in Visual Basic and utilizes Active Data Objects (ADO).

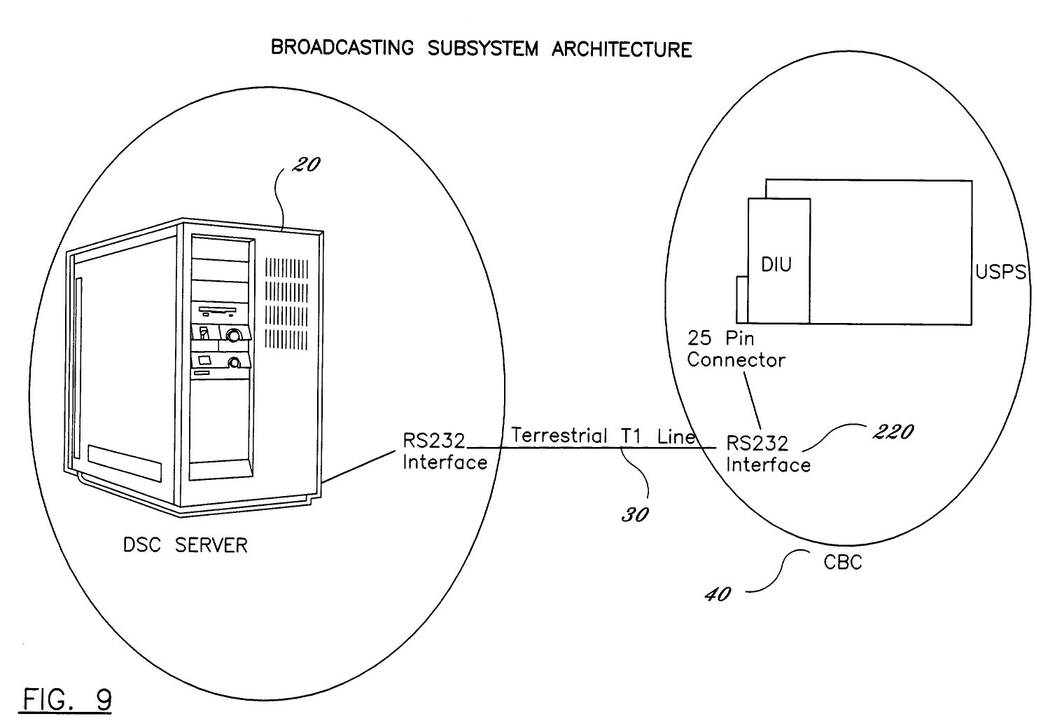

FIG. 9 shows the broadcasting subsystem architecture of the present invention. Once the Internet information has been obtained, edited and processed, it is sent, via T1 terrestrial link 30, to the Central Broadcasting Center 40. The information is transmitted to a specific port of a DIU belonging to whatever transponder (USPS) is being used to broadcast data. The interface to the DIU is an RS-232 line.

On the USPS, a channel is allocated as follows:

| | |
|---|---|
| RATE: | 10,000 |
| STATE: | Active |
| APF: | 10 |
| PROTOCOL: | RS-232 |
| PARITY: | None |
| START BITS: | 1 |
| WIDTH: | 8 |
| BAUD: | 4800 |

A viewer channel is created that “points” to the appropriate SCID and has the proper transponder number. The channel has an SPI of 0 with 2 explicit SCIDs; one with S typed of 13 (continuous data) and SCID#X and the other with an audio S type with SCID# X+1. A PAD is sent for the appropriate SCID. A service ID is given to the channel that is correct for the CAM. PAD flag is set to “12”.

Steps that must be undertaken in order to pair internet data with corresponding-content video channels include:

selection of a SCID#

selection of BOC/VC

determine what existing video programming to use to attach the data onto; this will affect BOC and SCID assignments, as well as service IDs

selection of CSS Bits/CSS number of data

mapping of data BOCs to appropriate CAUS's that correspond to the transponders being used

The downstream subsystem of the present invention, as shown in FIG. 2, includes the user's antenna receiver satellite dish 60, the IRD 70 connected to the satellite dish, and the user's viewing device, typically a PC or PDA 80. The present invention allows for Internet data to be transmitted via a satellite network and arrive at the user's IRD to be viewed at his or her PC, without the need for a modem connection. The information is automatically stored in the PC's hard drive.

The IRD typically has two connections in its back. One is a telephone jack, which the user can use to hook up to a telephone line. The other connection is a low speed serial port. The common practice has been to use the serial port of the IRD for debugging purposes only and not for data transfer. The present invention utilizes this serial port in a unique fashion. A PC or PDA can be connected to the IRD via this serial port. Internet-content can be viewed on the user's PC via this serial port connection.

Although typically limited to a data rate of approximately 4800 bits per second (4.8 kbps), the serial port does allow for a constant seamless stream of information in the form of newspaper headlines, news summaries, stock quotes and various links. IRDs may be designed to accommodate faster data transfer, as high as 115,200 bps.

In addition to the Web page being transferred to the user, the server code also transfers additional Web information in the form of hyperlinks. A plurality of links are sent along with the Web page, further giving the user the impression that they he or she is connected to an interactive Internet system.

In an alternate embodiment of the present invention, in lieu of internet data, program guide information, representing, advanced television listings, is selected, organized and injected into the satellite network data stream.

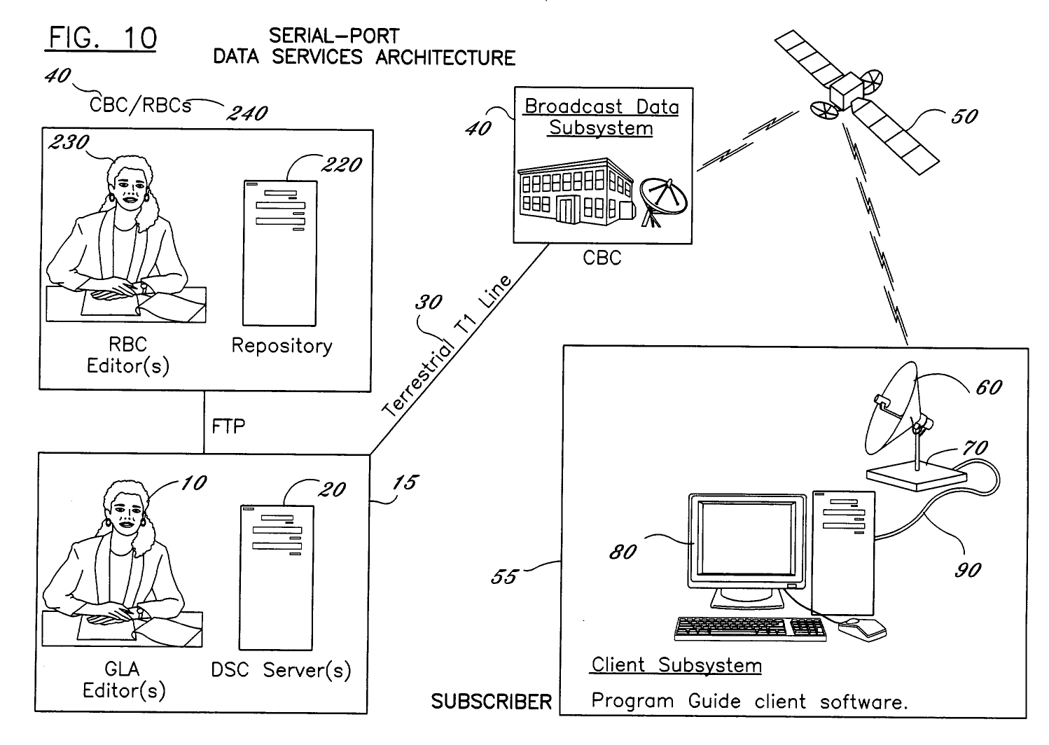

FIG. 10 shows a slightly modified architectural structure from the network of FIG. 1. FIG. 10 includes Content Repositories 220, within one or more Repository Broadcast Centers (RBCs) 240, usually situated within the user's geographic region, and contain editors 230 which prepare program guide data information as many as thirty days in advance. CBC 40 can also formulate the program information. These schedules are transmitted to DSC server 20 at DSC 15 in Microsoft Access (MDB) format.

The process is repeated once per day as new program guide information is received from CBC 40 or RBCs 240. The formatted program guide information then travels through the network as described earlier for HTML-formatted information.

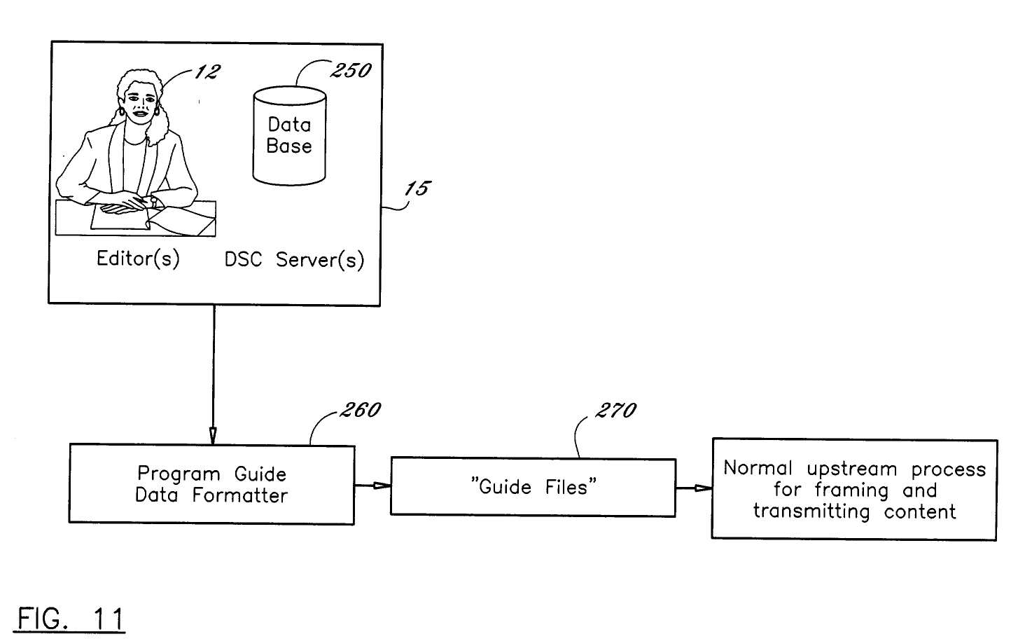

In FIG. 11, a guide database 250 is created at DSC 15. A program guide editor 12 is responsible for verifying the content of the program guide information received from CBC 40 and RBCs 240. Software running on DSC server 20 converts the program guide information to a format used by the program guide client software, via a Program Guide Data Formatter Module 260. Module 260 converts the program guide information into guide program files 270. The files contain information about a program such as the time it is being broadcast, the channel it is broadcast on, and a detailed description of the program. Guide files 270 then travel through the normal data stream to reach the user's viewing device.

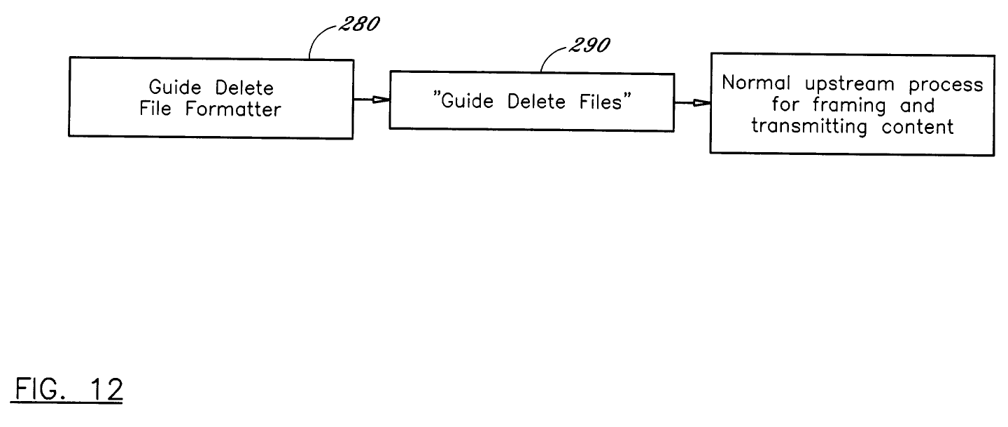

FIG. 12 includes module 280, a Guide-Delete File Formatter. Module 280 is an application that provides editor 12 with a convenient GUI to generate a “guide-delete” program guide file 290. A file of this type contains a single date that indicates which programs in database 250 should be considered outdated and subsequently removed. If a television program's end date is earlier than the specified date in guide-delete file 290, the television is removed from database 250.

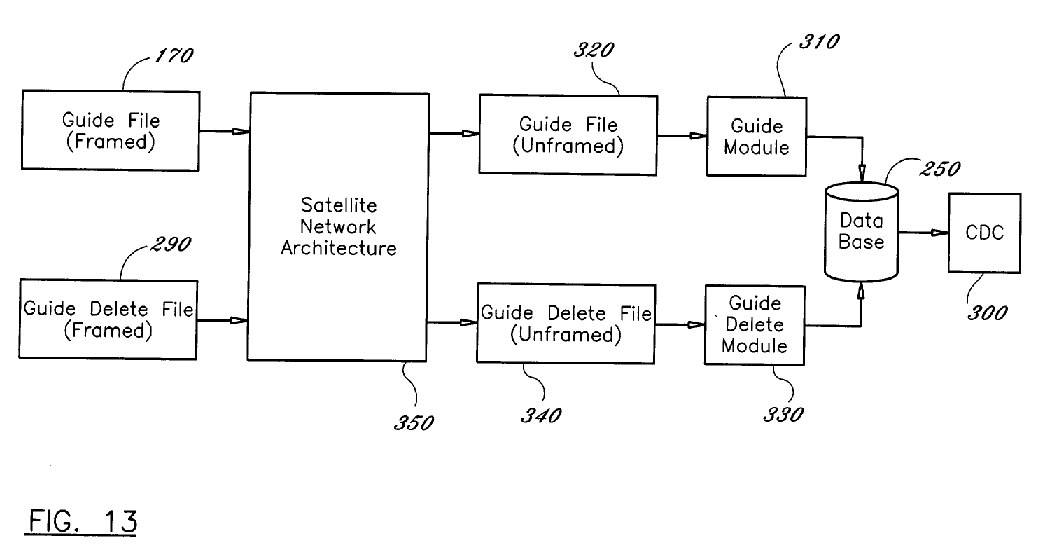

FIG. 13 shows the architecture for the program guide implementation, focusing upon the client subsystem, downstream from the satellite-network architecture, shown as 350. Two dynamic link libraries and a Client Display Component (CDC) 300, are seen in FIG. 13. Referring to FIG. 13, CDC 300 represents a collection of Dynamic HTML/JavaScript pages hosted within the Web browser to display the program guide. They provide the functionality for the user to select which time frame they wish to view the schedule over, and to get a detailed description of a particular program.

Guide module 310 is responsible for separating an unframed guide file 320 into a collection of programs and placing these programs in guide database 250. Guide Delete module 330 parses an unframed guide-delete file 340 and removes outdated programs from guide database 250. Information is considered outdated if the program's ending date is earlier than the date specified in guide-delete file 340. Module 330 also removes expired guide files 320 and guide-delete files 340 from the directory they reside in on the user's viewing device.

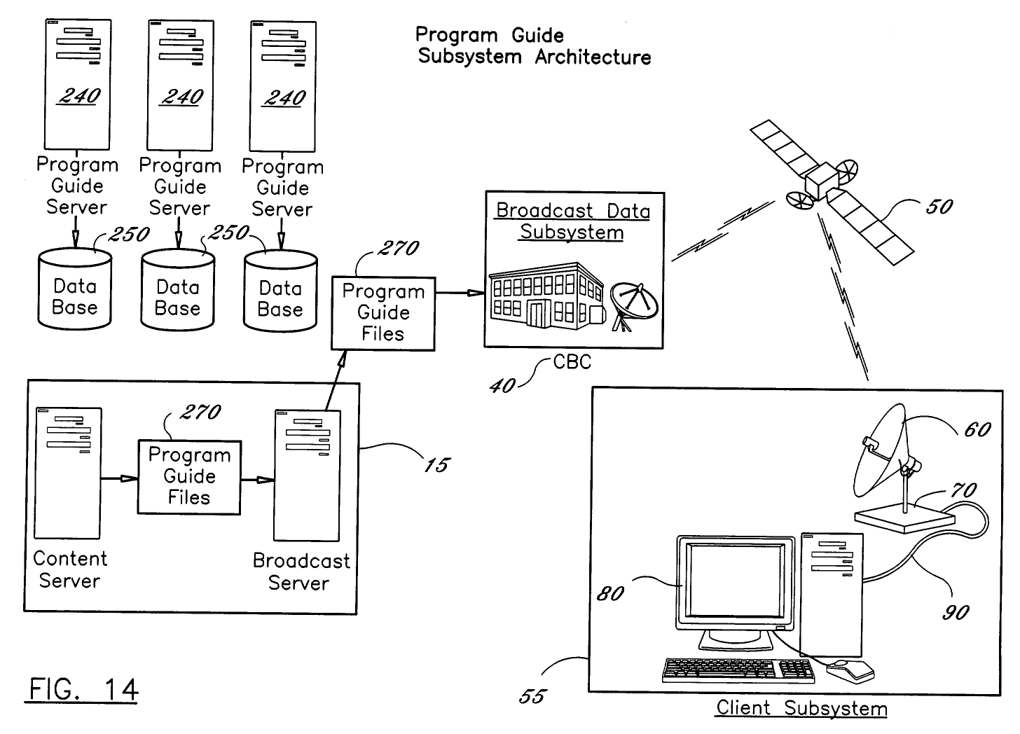

FIG. 14 illustrates the overall subsystem architecture of the program guide implementation of the present invention. RBCs 240 transmit their existing program guide databases 250 to DSC 15 preferably once per day. There, the Program Guide Data Formatter program converts RBC-formatted program guide databases into content compatible with conventional Internet-formatted data. The program guide files 270 are transmitted to CBC 40 with other information such as downloaded Internet data, and uplinked to one or more satellites 50. The user therefore receives advanced television program listings on his viewing device 80, via the broadcast downlink to antenna 60, IRD 70 and serial connection 90.

Each guide file 270 contains approximately 6 hours worth of programming information. Several hundred guide files 270 are transmitted periodically to the user to provide up to one month of advanced television schedule information. Again, the user receives this information on his or her viewing device via serial transmission by utilizing the low speed serial data port of the IRD.

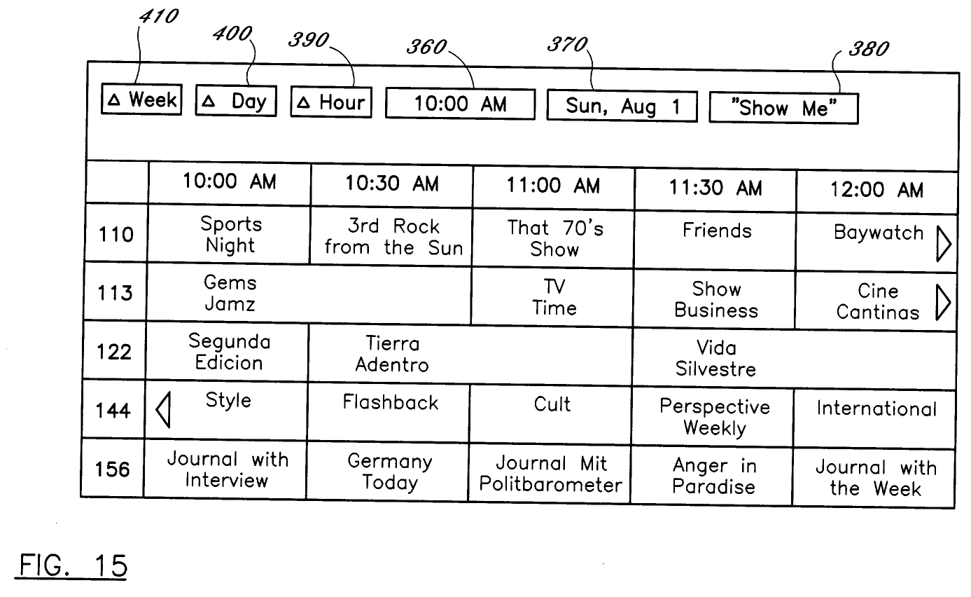

FIG. 15 illustrates a sample program guide seen by the user on his or her PC or PDA. The user can specify starting time 360 and date 370 and then click the “Show Me” button 380 to display the schedule. The user can offset the current schedule one hour back or one hour forward via button 390. Similarly, button 400 can offset the schedule by one day, and button 410 can be used to obtain schedule listings one week earlier or one week later than the current date.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A DSS terrestrial-satellite communications network for delivering information to a viewing device without the need for a user to possess additional communications hardware, the network comprising:
means for selecting, acquiring and editing certain information;
a first network computer having memory storage means for storing said information;
a central network computer;
means for transmitting the information from said first network computer to said central network computer;
one or more communication satellites for receiving and transmitting broadcast signals;
uplink means coupling the information from said central network computer to said satellites in the form of said broadcast signals;
downlink means coupling said broadcast signals from said satellites to a receiving antenna situated within said satellite's coverage area;
an IRD connected to said receiving antenna;
said viewing device connected to said IRD via a low-speed serial data port to receive, the information, said viewing device containing means for displaying the information on said viewing device; and
a memory storage device situated within said viewing device.

2. The network of claim 1 wherein said viewing device is a personal computer.

3. The network of claim 1 wherein said viewing device is a PDA.

4. The network of claim 1 further comprising means for automatically storing said information in said memory storage device.

5. The network of claim 1 wherein said broadcast signals further comprise audio and video DSS signals bundled with the information, said audio and video signals corresponding to a selected television channel.

6. The network of claim 5 wherein said IRD further comprises means for extracting the information from said broadcast signals.

7. The network of claim 6 wherein the information is related to the subject matter of said selected television channel, thereby eliminating the need for separate channel allocation for broadcasting of the information.

8. The network of claim 1 further comprising a second network computer for processing, formatting and storing said information.

9. The network of claim 1 wherein the information comprises television program guide data.

10. The network of claim 9 wherein said program guide data is compiled at one or more repository broadcast centers situated at a location remote from said first network computer, and transmitted to said first network computer.

11. The network of claim 10 wherein said program guide data comprises television program information for an entire channel over the course of a predetermined number of hours.

12. A DSS terrestrial-satellite internet communications network for delivering HTML-formatted information retrieved from the internet to a viewing device without the need for a user to possess additional communications hardware, the network comprising:
means for selecting, acquiring and editing certain HTML-formatted information retrieved from the internet;
a first network computer having memory storage means for storing said information;
a central network computer;
means for transmitting the information from said first network computer to said central network computer;
one or more communication satellites for receiving and transmitting broadcast signals;
uplink means coupling the information from said central network computer to said satellites in the form of said broadcast signals;
downlink means coupling said broadcast signals from said satellites to a receiving antenna situated within said satellite's coverage area;
an IRD connected to said receiving antenna;
said viewing device connected to said IRD via a low-speed serial data port to receive the information, said viewing device containing means for displaying the information on said viewing device; and
a memory storage device situated within said viewing device.

13. The network of claim 12 wherein said viewing device is a personal computer.

14. The network of claim 12 wherein said viewing device is a PDA.

15. The network of claim 12 further comprising means for automatically storing the information on said viewing device's memory storage device.

16. The network of claim 12 wherein said means for displaying said information comprises a browser.

17. The network of claim 12 wherein said broadcast signals further comprise audio and video DSS signals bundled with the information, said audio and video signals corresponding to a selected television channel.

18. The network of claim 17 wherein said IRD further comprises means for extracting the HTML-formatted information from said broadcast signals.

19. The network of claim 18 wherein the information is related to the subject matter of said selected television channel, thereby eliminating the need for separate channel allocation for the broadcasting of the information.

20. The network of claim 12 further comprising a second network computer for processing, formatting and storing said information.

21. The network of claim 12 wherein the information further comprises television program guide data.

22. The network of claim 21 wherein said program guide data is compiled at one or more repository broadcast centers situated at a location remote from said first network computer, and transmitted to said first network computer.

23. The network of claim 22 wherein said program guide data comprises television program information for an entire channel over the course of a predetermined number of hours.

24. An IRD incorporated into a DSS terrestrial-satellite communications network, said IRD capable of transmitting received satellite-broadcast signals including data information, said IRD comprising:
a first port to provide linking means to a television; and
a second port to provide linking means to a viewing device, wherein said linking means is a low-speed serial data port capable of transferring the information to said viewing device without the need for a user to possess a dedicated telephone line or a modem.

25. The IRD of claim 24 wherein said broadcast signals comprise audio and video signals bundled with the information.

26. The IRD of claim 24 wherein said viewing device is a personal computer.

27. The IRD of claim 24 wherein said viewing device is a PDA.

28. A method for delivering information to a viewing device via a terrestrial-satellite communications network without the need for a user to possess additional communications hardware comprising the steps of:
selecting, retrieving and storing information on a first network computer;
transferring said information to a central network computer where said information is stored;
uplinking said information from said central network computer to one or more said satellites in the form of a broadcast signal;
downlinking said broadcast signals from said satellites to a receiving antenna connected to an IRD;
transmitting said information from said IRD to said viewing device, said viewing device connected to said IRD via a low speed serial data port, said viewing device further including a memory storage device; and
displaying said information on said viewing device via displaying means.

29. The method of claim 28 further comprising the step of automatically storing said information on a memory storage device situated within said viewing device.

30. The method of claim 28 wherein said broadcast signals comprise audio and video signals bundled with said information, said audio and video signals corresponding to a selected television channel.

31. The method of claim 30 further comprising the step of extracting the information from said broadcast signal.

32. The method of claim 31 wherein the information is related to the subject matter of said selected television channel, thereby eliminating the need for separate channel allocation for the broadcasting of said information.

33. The method of claim 32 wherein the information comprises HTML-formatted data retrieved from the internet.

34. The method of claim 33 wherein said displaying means comprises a browser.

35. The method of claim 28 wherein the information comprises television program guide data.

36. The method of claim 28 wherein the information comprises television program guide data and HTML-formatted information retrieved from the internet.

37. The method of 36 wherein said program guide data is compiled at one or more repository broadcast centers situated at a location remote from said first network comp
